(19) United States
(12) Patent Application Publication
(10) Pub. No.: US 2022/0250403 A1
(43) Pub. Date: Aug. 11, 2022

(54) Method and Device to Help Struggling Readers on E-readers

(71) Applicant: Daniel Edward Crumbaugh, Allen, TX (US)

(72) Inventor: Daniel Edward Crumbaugh, Allen, TX (US)

(73) Assignee: Rush Creek LLC, Allen, TX (US)

(21) Appl. No.: 17/172,418

(22) Filed: Feb. 10, 2021

(51) Int. Cl. B42D 9/00

(52) U.S. Cl. CPC B42D 9/008

(57) ABSTRACT

The method consists of using a T-square shape device that slides up and down e-readers. It has a vision window that allows 1 line of text to be seen at a time. The key feature is the T-square shape that allows the vision window to always be parallel to the line of text. This device improves focus and concentration, decreases eye strain, and makes reading easier, especially for those who struggle with reading.

### FIELD OF THE INVENTION

This is a method to help struggling readers better read an e-book through the use of a device that allows the reader to see only a limited number of lines.

### BACKGROUND

Regarding readers who struggle to read, there are several current products. For print media the market now reading rulers to help struggling readers keep track of where they are in the text. These reading rulers may prove to be helpful, and they are very inexpensive. These rulers are transparent, for if they are not transparent, they rob the child of the context

While reading an e-book people can use a virtual reading ruler, which is a mobile tinted overlay that ‘floats’ above any application and is moved around the screen with a mouse. The Virtual Reading Ruler is an easy to configure virtual screen overlay for all computer reading. For many people reading from a computer can be more difficult than reading a page of text. Not only does the glare cause problems such as eye strain and headaches, you can't mark your place easily on a computer screen. The Virtual Reading Ruler works just like an ordinary Reading Ruler, removing the screen glare and stabilizing the print on any area of the page. At the same time it can mark the specific line or paragraph being read. However these virtual readers don't work on e-books as they require a mouse.

A big advantage that e-books offer struggling readers is that E-books can change background colors. While contrast can be provided by black text on a white background this is not so beneficial when considering dyslexia. Research suggests that pastel backgrounds, increased line-spacing, font choice and paragraph justification all have an effect.

While e-books offer some new tools, they don't know have any way to help the struggling reader focus on the line of the book that needs to be read next.

### Background—Prior Art Patents

There are prior art patents and patent applications that cover methods, software or devices to make reading an e-book easier, but they are targeted at proficient readers. U.S. Pat. No. 8,018,031, Zehr, is for a page turner, U.S. Pat. No. 8,950,682, Zehr, is a patent for dual displays of an e-book, U.S. Pat. No. 9,262,063, Kim, is for a touch screen display that allows quick page turning of one or more pages, 20110039602, McNamara is a touch screen display for content reading on a mobile device, 20150026161, Bullock, is for an enhanced e-book that allows content storage, and 20170136800, Naiza is an application for an e-book reader that allows the lines of text to be slanted.

None of the prior patents deals with enhanced tools for the struggling reader.

### SUMMARY OF THE METHOD THE DEVICE

The method consists of using a T square shape device that can be slid up and down the e-reader with the T component of the T shaped device positioned on the edge of the e-reader and the portion of the T shaped device extending over the text of the e-reader having an opening that shows one line of text, which helps struggling readers see the one line of text they are looking to read. The method can also be used on reading books and notebooks.

The device consists of a rectangle frame with a window that allows the reader to see one line at a time, a T component extends downward from the frame so that it will be position on the side edge of the e-reader, support pieces that can fill in from either side of the window, to take away the white margin of the e-reader. The T Square shape device comes in numerous widths that relate to the popular models on the market. Those widths are: 4.6 inches; 4.5 inches; 4.7 inches; 5.4 inches; 6.26 inches; 6.8 inches; 7 inches; and 8.46 inches. The T component of the device extends down from the rectangular window frame on the side of the edge of the e-reader.

A second embodiment includes a clip from the T section of the device which goes under the e-reader to hold the device in position on the e-reader. Another embodiment includes adding a color film, or other transparent color structure to the window of the device to improve contrast for the reader. Another embodiment consists of adding a sliding feature to the frame around the window to allow flexibility in the size of the e-reader, the slider moving in and out of the T component of the device. A final embodiment adds a small clip from the T section of the device that holds the rectangular piece, that covers the white space around the text, in place.

### BRIEF DESCRIPTION OF DRAWINGS

FIG. 1 shows a ¾ view of the device when in use the T component faces down and slides along the side of the e-reader.

FIG. 2 shows a top view of the device. Of note in this figure are the rectangles that sit inside the device's window on either end, the rectangles can cut off the white space on the ends of the line being read.

FIG. 3 shows a bottom view of the device.

FIGS. 4 and 5 show a clip which is used in a second embodiment to hold the T square shape device on the e-reader. Note, both figures show the device with the bottom side up.

FIG. 6 shows a tinted color film can be inserted into the wind to facilitate reading of the line in the window

FIGS. 7a and 7b show how the width of the device can be varied by the use of a slider mechanism that goes into the T component of the device.

### BRIEF DESCRIPTION OF THE FEATURE NUMBERS IN THE DRAWINGS

1. The device.
2. The device's window for reading a line of text.
3. The devices T component on one end.
4. The frame around the window.
5. The rectangle that can close off the white area between the text end of the window.
6. A clip that hold the device in place in relation to the e-reader.
7. A transparent piece that fits into the window of the device to facilitate reading of the line.
8. Adjustable slider.
9. A second clip that can be used to hold in place the rectangle that closes off the white area between the text and the end of the window.

### DETAILED DESCRIPTION OF THE INVENTION

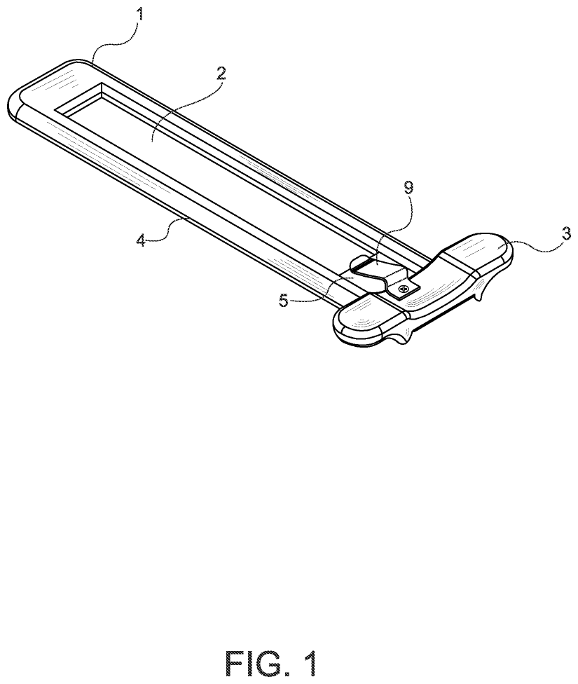

FIG. 1 shows the device 1 with the Tee shaped component 3 on one end, the frame around the window 4, and the device's window for one line 3. The component 3 comes down slightly from the frame to hold the device parallel to the T component writing on the e-reader. The figure also shows the rectangular piece 5 which can shut off the white space next to the line being read and the optional second clip 9 that can hold the rectangular piece in place. The rounded shape on the corners of the frame around the window 4, and the shape of the T component 3 are for illustrative effects only, the frame around the window 4 may have a variety of shapes on the four corners of the window, and the T shaped component 3 can have a wide variety of designs.

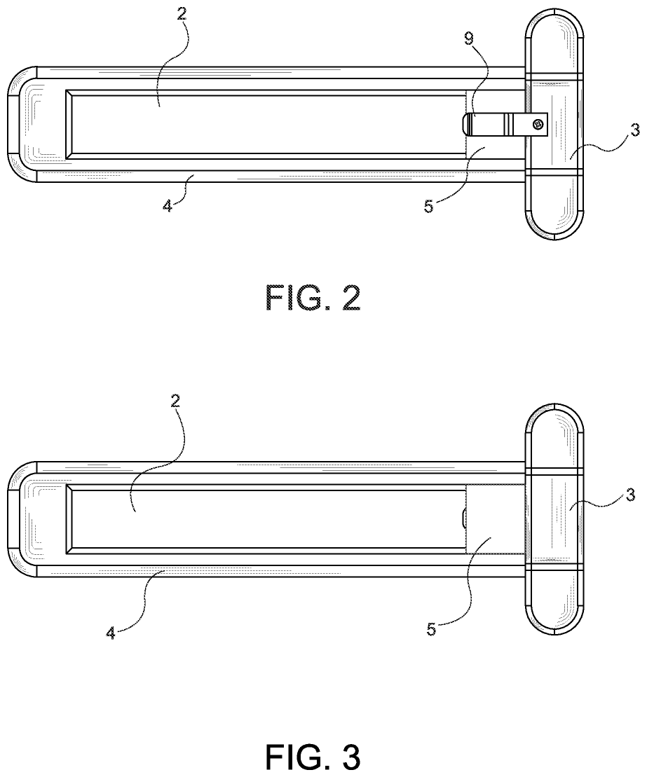

FIG. 2 shows the window, 2 which come in a wide variety of lengths, from a top view, plus the T shaped component 3 and the rectangle piece 5 which can shut off the white space next to the line being read, and the optional second clip 9 that can hold the rectangular piece in place.

FIG. 3 is a bottom view that shows how the T component 3, the frame 4 around the window 2. In use the frame around the window 4 is turned upside down from this view.

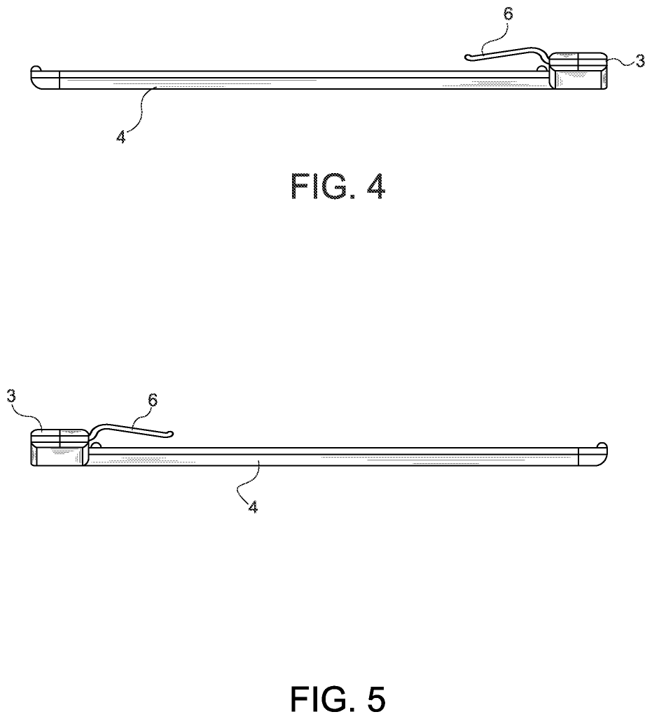

FIG. 4 shows an alternative embodiment where a clip 7 is attached to the T component 3 to assist in folding the device 1 in place over the line of text being read. FIG. 4 also shows how the T component 3 extends down from the frame so it can rest along the side of the e-reader. The device is turned over 180 degrees from the view of this figure when in use.

FIG. 5 shows how the device would be used with the T component 3 on the opposite side of the e-reader from FIG. 4.

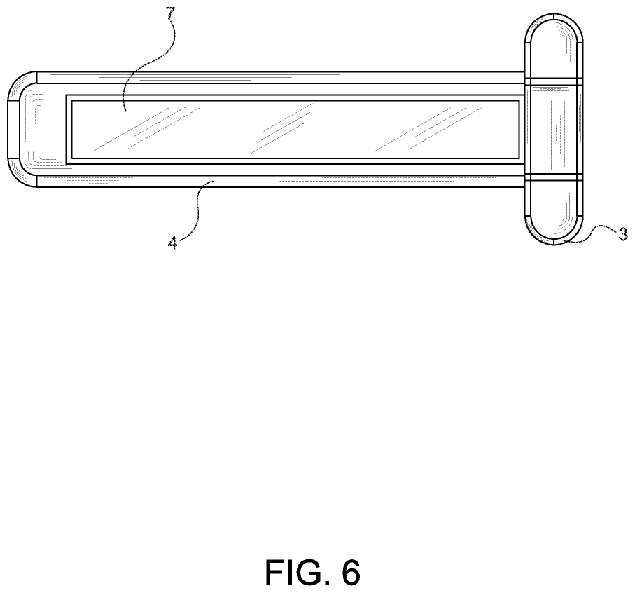

FIG. 6 shows how an optional transparent colored piece 8 can inserted into the window 2 to help offer additional contrast for reading.

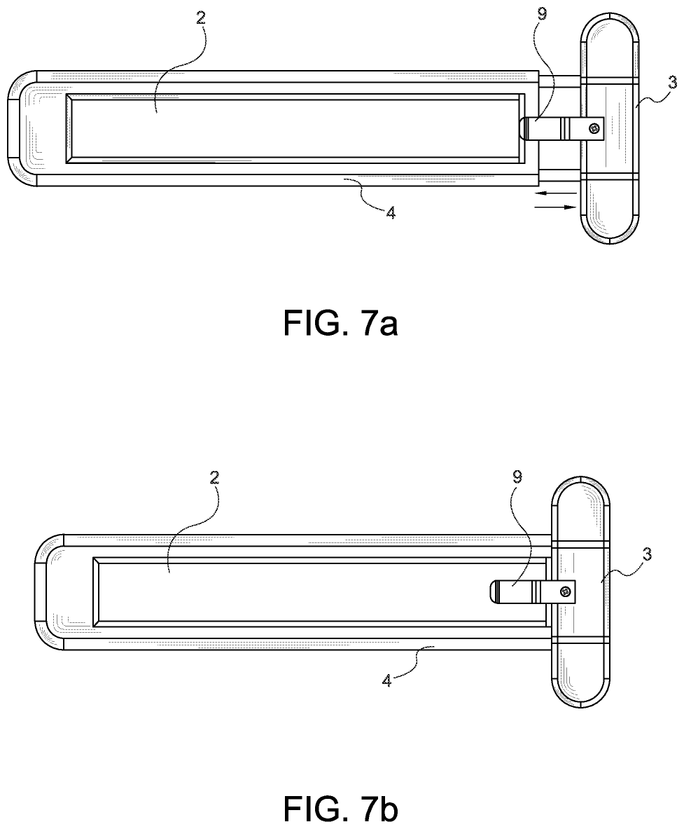

FIGS. 7a and 7b show the adjustable slider and how it can vary the width of the frame around the window 4 to adjust the overall with of the device 1 to fit the size of more e-readers. FIG. 7a shows the device being extended, and FIG. 7b shows the device in its non-extended version.

I claim:

1. A method of reading an e-reader comprising the of using a T square shape device that can be slid up and down the e-reader with a T component of the T shaped device positioned on the edge of the e-reader and the portion of the T shaped device extending over the text of the e-reader having a window that shows one line of text;
Whereby text on a screen is read line by line by moving the device downward to the next line of text after one line of text has been read.

2. A device comprising:
a rectangle frame with a window that allows the reader to see one line at a time;
a T component and that extends downward from the side of the e-reader so that it will be positioned on the side edge of the e-reader;

3. The device of claim 1 with rectangular pieces that can fill in from either side of the window, to take away the white margin of the e-reader.

4. The device of claim 1 with a clip from the T section of the device which goes under the e-reader to hold the device in position on the e-reader.

5. The device of claim 1 that includes adding a transparent color structure or material to the window of the device to improve contrast for the reader.

6. The device of claim 1 that adds a sliding feature to the frame around the window to allow changes in width of the device.

7. The device of claim 3 with a second clip that holds the rectangular piece in place, the second clip being attached to the T component.
